(19) United States
(12) Patent Application Publication
(10) Pub. No.: US 2014/0337869 A1
(43) Pub. Date: Nov. 13, 2014

(54) USER BEHAVIOR BASED DATA POPULATION OF DEVICES

(71) Applicants: Susan Alice Faulkner, Portland, OR (US); Francoise Bourdonnec, Portland, OR (US); Rita H. Wouhaybi, Portland, OR (US)

(72) Inventors: Susan Alice Faulkner, Portland, OR (US); Francoise Bourdonnec, Portland, OR (US); Rita H. Wouhaybi, Portland, OR (US)

(21) Appl. No.: 13/995,120

(22) PCT Filed: Dec. 21, 2011
(86) PCT No.: PCT/US11/66552

§ 371 Date: Oct. 18, 2013

(51) Int. Cl. H04N 21/258; H04N 21/482; H04N 21/24

(52) U.S. Cl. CPC H04N 21/25891; H04N 21/2408; H04N 21/482
USPC 725/14

(57) ABSTRACT

A system and method include tracking user behavior exhibited by interaction with a device, creating a preference profile as a function of the tracked user behavior, accessing the preference profile prior to populating the device, and using the preference profile to select an order of population of the device.

### BACKGROUND

When a user buys a new device such as a set-top box, or otherwise needs a device to be populated with content data such as an electronic programming guide (EPG) listing television shows and corresponding stations, the population of such a device with a content guide can occur when the device is first purchased or after a reboot or an upgrade of the system. A reboot may be required after an interruption in power supplied to the device such as following a power outage or if the device has been unplugged by the user for a variety of reasons. Obtaining and loading all the data into the device can take many hours. In the meantime, the user is stuck waiting for the data about their favorite shows and channels to appear and cannot see what is coming up next in the electronic programming guide. Additionally, programming information reappears in the EPG in numerical order starting at channel 1. A viewer may have to wait for a significant amount of time for channels in the hundreds to appear.

### BRIEF DESCRIPTION OF THE DRAWINGS

FIG. 1 is a block diagram of a system to populate devices with data based on user behavior according to an example embodiment.

FIG. 2 is a flowchart illustrating a method of capturing user behavior and using the user behavior to prioritize populating device according to an example embodiment.

FIG. 3 is a flowchart illustrating modification of a list based on soon to occur programs or events in accordance with an example embodiment.

FIG. 4 is a block diagram of a specifically programmed machine for performing methods and functions according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

If a viewer usually watches high-definition channels starting, for instance, at 700, it can take hours for any pertinent information to appear as an electronic programming guide (EPG) is loading when a device is first connected to a source of multiple channels of content such as a cable system. In various embodiments, a system and method harvest a user's previous behavior from one or more devices that the user uses. As a result, when a server, also referred to as an operator is populating data in the device, the operator first obtains information about the user's behavior to prioritize loading of data, including synching and populating the data.

In one example, the operator populates a content directory of a device for channels 700-800 before populating lower numbered channels. Also, specific channel information can show up first, such as channels in the user's favorite list or top 10 most used by the specific user. As a result, the most relevant or interesting data is accessible to the user faster. The same method can be used for other devices and service operators.

Prior systems including set-top boxes and televisions are oblivious to user's preferences and previous behavior. The embodiments described herein can enable more responsive experiences. This is especially useful in cases where users are more sensitive to power usage and turn off these devices on a regular basis when not in use (i.e. in China users turn off the power of their cable and set-top boxes when they are not watching TV). As a result the update and channel content populating needs to happen on a frequent basis.

The system and method may be used for a wide range of applications and devices. For example, a mobile phone user can also take advantage of such a solution that would allow them to bootstrap a new device or even restore their original device after a failure using their preferences in order to decide on the priority of the restore. The device may subscribe to a service and as the user is interacting with the service, the service creates a profile of behavior noting favorite or most used applications and services. The device itself can create the profile in some embodiments and send the profile to the operator or server. The profile is then saved on a computer readable storage device, such as the cloud, server, or among the rest of the devices belonging to the user in order to create redundancy where it can be queried. When a content provider needs to push a large update or a system restore to one of the devices, it queries the saved preferences in order to obtain an ordered list of the things that need to be deployed. Such a system can also have security and privacy enabled so that the content provider cannot really query the system without an encrypted digital proof that they need this info, thus blocking attempts to snoop user behavior.

In further embodiments, the system may also be used to prioritize an order in which to deploy data to or restore devices in case a service or operator needs to deploy data to more than one device. For example, if a household has more than one set-top box, following a power outage, the one that is more in use should receive the data population first and in the order of favorites. The order may also be determined taking into account time of day, and which device is more likely to be used given a history of use of the devices.

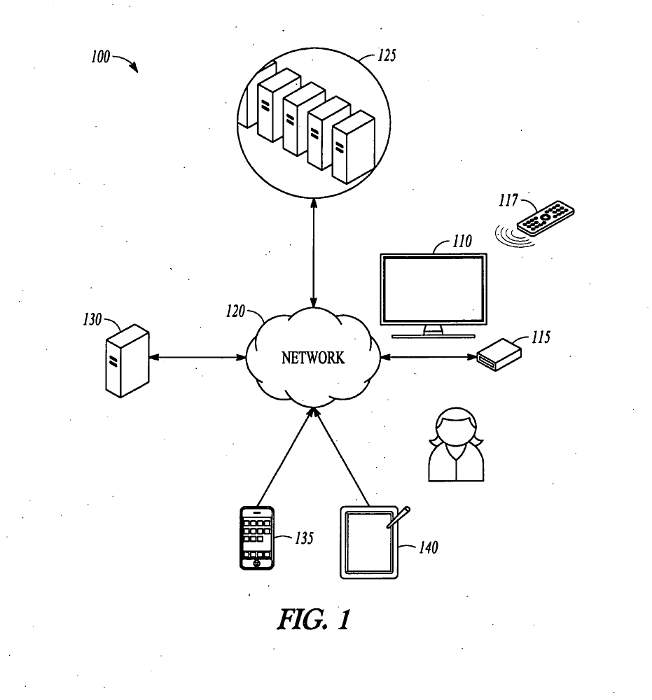

FIG. 1 is a block diagram of a network and system 100 according to an example embodiment. A television 110 is coupled to a set top box 115. A user may interact with the set top box 115 and television via a remote control illustrated at 117 to select content for viewing and recording, and control performance of the content by the television, including audio. The set top box 115 is further coupled to a network indicated at 120 to receive content, data, and programming instructions from a content provider server 125 such as a data/program server. In various embodiments, the network may be a private network such as a cable or fiber optic network, and may also represent the Internet. In still further embodiments, the network 120 is a connection to a satellite for uplink and downlink of content and instructions. The content provider may be a cable system operator, satellite television provider or web based server in various embodiments.

As the user selects content such as via remote controller 117, the set top box 115 captures the user behavior and either forwards it on through the network 120 to a profile server, referred to as a preference server 130 to create a profile of user preferences, or directly creates the profile and sends the profile on to the preference server 130. In various embodiments, the data/program server and preference server may reside on a single server, or in a cloud. In further embodiments, the servers may be separately owned and implemented in different geographic locations.

In further embodiments, the user behaviors may also be captured for smart phones 135 and tablet devices 140. The behaviors may then be used to prioritize data to be loaded onto such devices when rebooting in order to enable the devices to provide services that are more likely to be needed quickly by a user of the device based on prior user behavior. For example, in a data restore scenario, apps that are more used by the user could be restored first rather than some other random order such as alphabetical.

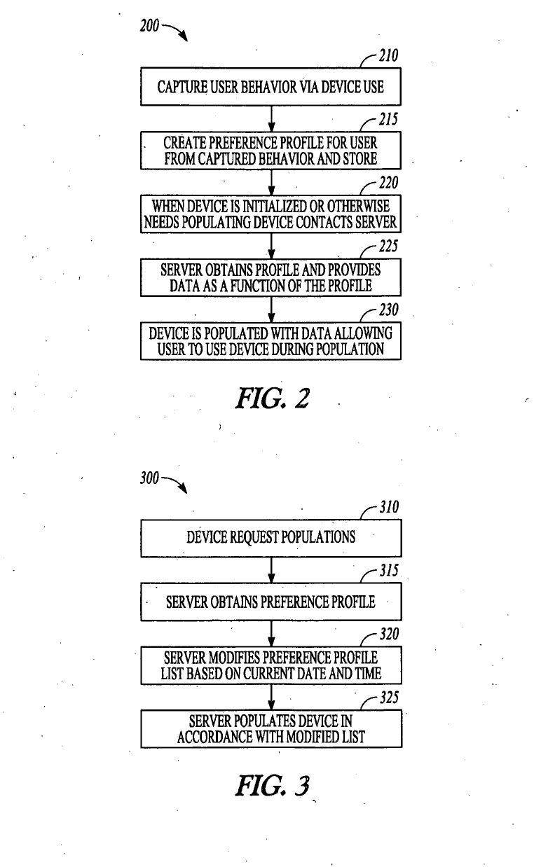

FIG. 2 is a flow diagram illustrating a method 200 of capturing user behavior and using the captured behavior to prioritize populating devices when rebooting or first initializing the devices. As a device is being used, such as to control content displayed on a television, user behavior is captured at 210. Channel selections may be used to represent user behavior, along with the length of time a particular program or TV channel may be viewed. If the program is viewed most if not all of the times that it occurs, that information may be derived from the user interaction with the device, such as via a remote control for the set top box, which controls the content displayed on the television.

A preference profile for the user is then created at 215 from the captured behavior. The preference profile is then stored on a computer readable storage device. In one simple form, the preference profile may contain a list of channels viewed, sorted based on the total viewing time or number of viewings associated with each channel. The profile may also list a range of channels about the most frequently viewed channel or channels. For instance, as referenced above, if the most viewed channels are from a group of high definition channels, the profile may identify the entire group of high definition channels, or individual channels within the group. The content of the profile may be adjusted as a function of the amount of time needed to populate the group of channels as opposed to individual channels. If several most frequently viewed channels are from different logical or physical groupings, the channels may be loaded independently from their groups to provide the user with preferred channels more quickly on booting.

At 220, when a device is initialized or otherwise needs populating, the device may contact the content provider server 125 or operator to obtain the data used to populate the device. The content provider server at 225 then obtains the profile from the preference server and provides the data as a function of the profile. The profile may be located on another user device, a backup user device, a separate preference server, or on storage directly accessible to the server 225.

At 230, the device is populated with the data provided by the content provider server 225, allowing the user to use the device with data that has been already loaded, and correlates with the informtion on user behavior in the preference profile.

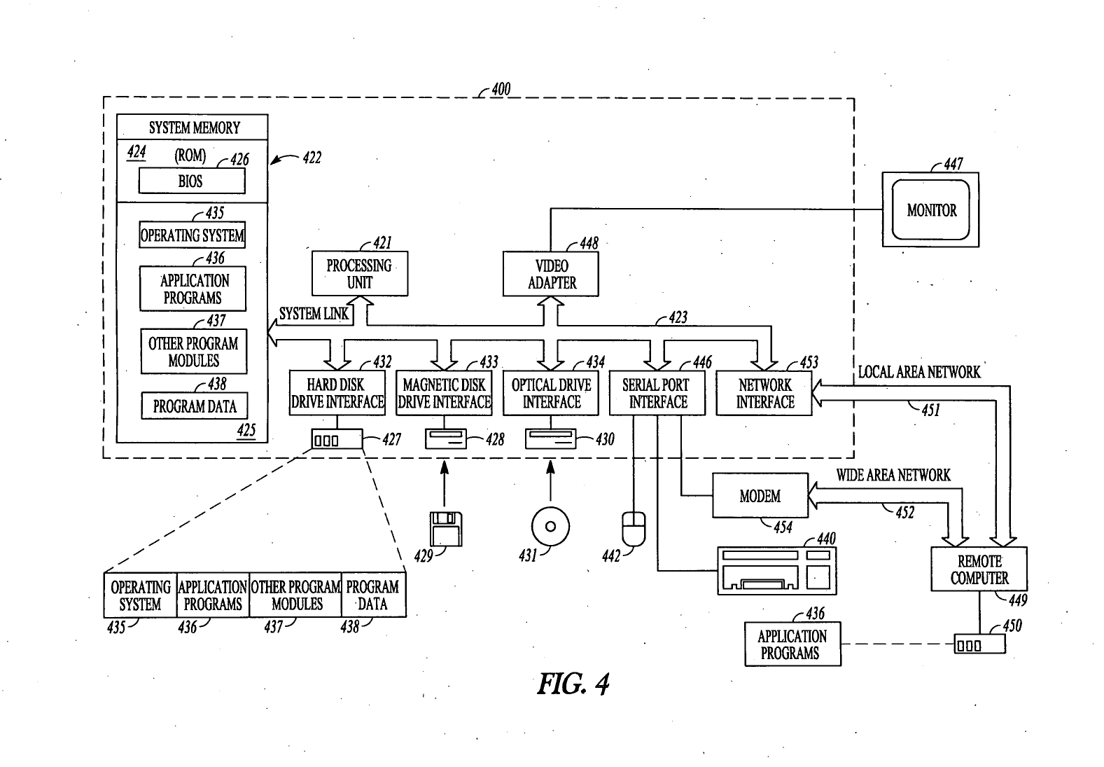

In further embodiments, user preferences may be tied to day of week, current date and time of day, specific, programs or events which may occur on different days, etc. This information may be used to modify the order of data to be loaded such that a channel having a program scheduled within a specified time, such as shortly after the start of loading and indicated by the profile to be regularly viewed, will be given a higher priority for loading. The specified time may be within two hours of the start of loading in some embodiments, or within other time periods such as one hour, three hours, etc. One method 300 is illustrated in FIG. 3. At 310, a request to repopulate a device is received by a content provider server or other provider device. The request may include encrypted digital proof in some embodiments. At 315, the content provider server obtains the preference profile utilizing the proof if necessary. At 320, the content provider server notes the current date and time, and modifies the preference profile list if particular time slots or corresponding programs are to occur shortly. At 325, the server populates the device in accordance with the modified list. When the preference profile is obtained to populate the device, it may first be scanned based on the time of day to re-prioritize the list and hence order of downloading. In various embodiments, the list may be a list of channels for which to load the data, or may be particular programming associated with one or more channels in further embodiments. The list may be varied in accordance with the type of data with which the device is to be populated. For instance, if a soon to occur program is on channel 714, then a program guide may either be loaded with all programming for channel 714 in a prioritized manner, or information related to a favorite program on that channel that is soon to occur can be loaded first, followed by the rest of the channel, or other soon to occur programming on the same or other channels.

In some embodiments, the user profile may prioritize groups of channels related to particular subjects, like college football, baseball, a favorite team, etc. Program genre may also be used to group particular programs together for early loading even if not on the same channel or closely numbered channels. Granularity of groups can also be varied as desired.

In some embodiments, a user may use many devices. A single profile may be used for some or all of the devices being used by the user in one embodiment, essentially sharing a profile between the different devices. Each device may also have a separate profile, as the devices may be used for different purposes by the user. In further embodiments, a user may edit the preferences profile to affect a desired order of loading.

FIG. 4 is a block diagram of a specifically programmed computer system to implement methods according to an example embodiment. In the embodiment shown in FIG. 4, a hardware and operating environment is provided to enable the computer system to execute one or more methods and functions that are described herein.

As shown in FIG. 4, one embodiment of the hardware and operating environment includes a general purpose computing device in the form of a computer 400 (e.g., a personal computer, workstation, or server), including one or more processing units 421, a system memory 422, and a system link 423, such as for example a bus or interconnect that operatively couples various system components including the system memory 422 to the processing unit 421. There may be only one or there may be more than one processing unit 421, such that the processor of computer 400 comprises a single processing unit, or a plurality of processing units, commonly referred to as a multiprocessor or parallel-processor environment. In various embodiments, computer 400 is a conventional computer, a distributed computer, or any other type of computer.

The link 423 can be any of several types of bus or interconnect structures including a memory bus or interconnect or memory controller, a peripheral bus or interconnect, and a local bus or interconnect using any of a variety of bus architectures. The system memory may also be referred to as simply the memory, and, in some embodiments, includes read-only memory (ROM) 424 and random-access memory (RAM) 425. A basic input/output system (BIOS) program 426, containing the basic routines that help to transfer information between elements within the computer 400, such as during start-up, may be stored in ROM 424. The computer 400 further includes a hard disk drive 427 for reading from and writing to a hard disk, not shown, a magnetic disk drive 428 for reading from or writing to a removable magnetic disk 429, and an optical disk drive 430 for reading from or writing to a removable optical disk 431 such as a CD ROM or other optical media.

The hard disk drive 427, magnetic disk drive 428, and optical disk drive 430 couple with a hard disk drive interface 432, a magnetic disk drive interface 433, and an optical disk drive interface 434, respectively. The drives and their associated computer-readable media provide non volatile storage of computer-readable instructions, data structures, program modules and other data for the computer 400. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 429, optical disk 431, ROM 424, or RAM 425, including an operating system 435, one or more application programs 436, other program modules 437, and program data 438. Programming for implementing one or more processes or method described herein may be resident on any one or number of these computer-readable media.

A user may enter commands and information into computer 400 through input devices sucH as a keyboard 440 and pointing device 442. Other input devices (not shown) can include a microphone, joystick, game pad, satellite dish, scanner, or the like. These other input devices are often connected to the processing unit 421 through a serial port interface 446 that is coupled to the link 423, but can be connected by other interfaces, such as a parallel port, game port, or a universal serial bus (USB). A monitor 447 or other type of display device can also be connected to the link 423 via an interface, such as a video adapter 448. The monitor 447 can display a graphical user interface for the user. In addition to the monitor 447, computers typically include other peripheral output devices (not shown), such as speakers and printers.

The computer 400 may operate in a networked environment using logical connections to one or more remote computers or servers, such as remote computer 449. These logical connections are achieved by a communication device coupled to or a part of the computer 400; the invention is not limited to a particular type of communications device. The remote computer 449 can be another computer, a server, a router, a network PC, a client, a peer device or other common network node, and typically includes many or all of the elements described above I/O relative to the computer 400, although only a memory storage device 450 has been illustrated. The logical connections depicted in FIG. 4 include a local area network (LAN) 451 and/or a wide area network (WAN) 452. Such networking environments are commonplace in office networks, enterprise-wide computer networks, intranets and the internet, which are all types of networks.

When used in a LAN-networking environment, the computer 400 is connected to the LAN 451 through a network interface or adapter 453, which is one type of communications device. In some embodiments, when used in a WAN-networking environment, the computer 400 typically includes a modem 454 (another type of communications device) or any other type of communications device, e.g., a wireless transceiver, for establishing communications over the wide-area network 452, such as the internet. The modem 454, which may be internal or external, is connected to the link 423 via the serial port interface 446. In a networked environment, program modules depicted relative to the computer 400 can be stored in the remote memory storage device 450 of remote computer, or server 449. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

### EXAMPLES

A method for populating a user device with data, the method including ttracking user behavior exhibited by interaction with a device, creating a preference profile as a function of the tracked user behavior, accessing the preference profile prior to populating the device, and using the preference profile to select an order of population of the device.

In one embodiment, the preference profile comprises a prioritized list of television channels. The behavior is transmitted to a server, and wherein the server creates the preference profile. The server queries the preference profile following a request to populate the device, and downloads data to the device in accordance with an order identified in the preference profile. In further embodiments, the server provides encrypted digital proof of authority to access the preference profile. In further embodiments, the device is a set top box, and user interactions with the set top box via a remote control device are tracked as user behavior. In still further embodiments, the user interactions include channel selections, length of time and number of times channels are selected. The preference profile lists individual programs associated with the channels selected at particular times. The method may also include modifying the order of population of the device by giving priority to a program on the preference profile that will be playing within a specified time. The preference profile lists groups of television channels.

A computer readable storage device has instructions for causing a machine to perform a method including ttracking user behavior exhibited by interaction with a device, creating a preference profile as a function of the tracked user behavior, accessing the preference profile prior to populating the device, and using the preference profile to select an order of population of the device.

In one embodiment, the preference profile comprises a prioritized list of television channels. The behavior may be transmitted to a server and server creates the preference profile, queries the preference profile following a request to populate the device, and downloads data to the device in accordance with an order identified in the preference profile. The server may also provide encrypted digital proof of authority to access the preference profile. The device may be a set top box. User interactions with the set top box via a remote control device may be tracked as user behavior. The user interactions may include channel selections length of time, and number of times channels are selected. In a further embodiment, the method includes modifying the order of population of the device by giving priority to a program on the preference profile that will be playing within a specified time.

A system includes a server to receive a preference profile responsive to a request to repopulate a device, wherein the preference profile is created from tracked user behavior exhibited by interaction with a device, and a content provider to use the preference profile to select an order of population of data to the device.

The preference profile includes a prioritized list of television channels. The server creates the preference profile responsive to user behavior with the device. The server further modifies the order of population of the device by giving priority to a program on the preference profile that will be playing within a specified time.

In still a further embodiment, a method includes accessing a preference profile representative of user interaction with a device, responsive to a command to populate the device, using the preference profile to select an order of population of the device, and sending population data to the device in accordance with the selected order.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method for populating a user device with data, the method comprising:
tracking user behavior exhibited by interaction with a device;
creating a preference profile as a function of the tracked user behavior;
accessing the preference profile prior to populating the device with data;
using the preference profile to select an order of population of data of the device; and
sending date to the device in the order selected.

2. The method of claim 1 wherein the preference profile comprises a prioritized list of preferences including favorite television channels and shows.

3. The method of claim 1 wherein the behavior is transmitted to a server, and wherein the server creates the preference profile.

4. The method of claim 3 wherein the server queries the preference profile following a request to populate the device, and downloads data to the device in accordance with an order identified in the preference profile.

5. The method of claim 3 wherein the server provides encrypted digital proof of authority to access the preference profile.

6. The method of claim 1 wherein the device is a set top box, and wherein user interactions with the set top box via a remote control device are tracked as user behavior.

7. The method of claim 6 wherein the user interactions include data identifying channel selections, length of time and number of times channels are selected.

8. The method of claim 6 wherein the preference profile lists individual data identifying programs associated with the channels selected at particular times, contacts list or apps on a mobile device.

9. The method of claim 6 and further comprising modifying the order of population of the device by giving priority to time sensitive data identifying a program on the preference profile that will be playing within a specified time.

10. The method of claim 1 wherein the preference profile lists data groupings, identifying groups of television channels or types of apps on a mobile device.

11. A computer readable storage device having instructions for causing a machine to perform a method, the method comprising:
tracking user behavior exhibited by interaction with a device;
creating a preference profile as a function of the tracked user behavior;
accessing the preference profile prior to populating the device with data;
using the preference profile to select an order of population of data of the device; and
sending date to the device in the order selected.

12. The computer readable storage device of claim 11 wherein the preference profile comprises a prioritized list of data identifying television channels.

13. The computer readable storage device of claim 11 wherein the behavior is transmitted to a server, and wherein the server creates the preference profile, and wherein the server queries the preference profile following a request to populate the device, and downloads data to the device in accordance with an order identified in the preference profile.

14. The computer readable storage device of claim 13 wherein the server provides encrypted digital proof of authority to access the preference profile.

15. The computer readable storage device of claim 11 wherein the device is a set top box, and wherein user interactions with the set top box via a remote control device is tracked as user behavior, wherein the user interactions include data identifying channel selections, length of time, and number of times channels are selected.

16. The computer readable storage device of claim 15 and further comprising modifying the order of population of the device by giving priority to time sensitive information, identifying a program on the preference profile that will be playing or needed within a specified time.

17. A system for populating a user device with data, the system comprising:
a server to receive a preference profile responsive to a request to repopulate a device, wherein the preference profile is created from tracked user behavior exhibited by interaction with a device; and
wherein the the server uses the preference profile to select an order of population of data to the device.

18. The system of claim 17 wherein the preference profile comprises data identifying a prioritized list of television channels.

19. The system of claim 17 wherein the server creates the preference profile responsive to user behavior with the device.

20. The system of claim 17 wherein the server further modifies the order of population of the device by giving priority to time sensitive information, identifying a program on the preference profile that will be playing or needed within a specified time.

21. A method for populating a user device with data, the method comprising:
accessing a preference profile representative of user interaction with a device, responsive to a command to populate the device;
using the preference profile to select an order of population of the device; and
sending population data to the device in accordance with the selected order.
